(19) United States
(12) Patent Application Publication
(10) Pub. No.: US 2012/0302254 A1
(43) Pub. Date: Nov. 29, 2012

(54) APPARATUS AND METHOD FOR DETERMINING A LOCATION OF WIRELESS COMMUNICATION DEVICES

(75) Inventors: Gilles Charbit, Hampshire (GB); Kari Rikkinen, Ii (FI); Tao Chen, Espoo (FI)

(73) Assignee: NOKIA CORPORATION, Espoo (FI)

(21) Appl. No.: 13/515,225

(22) PCT Filed: Nov. 23, 2010
(86) PCT No.: PCT/IB2010/055355

§ 371 Date: Aug. 7, 2012

Related U.S. Application Data
(60) Provisional application No. 61/286,256, filed on Dec. 14, 2009.

(51) Int. Cl. H04W 24/00

(52) U.S. Cl. 455/456.1

(57) ABSTRACT

An apparatus, system and method for determining a location of a wireless communication device employing machine-to-machine devices in a communication system. In one embodiment, the apparatus includes a processor 920 and memory 950 including computer program code. The memory 950 and the computer program code are configured to, with the processor 920, cause the apparatus to receive a list of machine-to-machine device identifiers for machine-to-machine devices, produce machine-to-machine measurement reports based of reference signals from the machine-to-machine devices on the list, and prepare the machine-to-machine measurement reports for transmission to a base station to determine a position of the apparatus.

### RELATED APPLICATIONS

This application claims the benefit of U.S. Provisional Application No. 61/286,256, entitled “Apparatus and Method for Determining a Location of Wireless Communication Devices,” filed on Dec. 14, 2009, which is incorporated herein by reference.

### TECHNICAL FIELD

The present invention is directed, in general, to communication systems and, in particular, to an apparatus, system and method for determining a location of a wireless communication device in a communication system.

### BACKGROUND

Long Term Evolution (“LTE”) of the Third Generation Partnership Project (“3GPP”), also referred to as 3GPP LTE, refers to research and development involving the 3GPP Release 8 and beyond, which is the name generally used to describe an ongoing effort across the industry aimed at identifying technologies and capabilities that can improve systems such as the Universal Mobile Telecommunication System (“UMTS”). The goals of this broadly based project include improving communication efficiency, lowering costs, improving services, making use of new spectrum opportunities, and achieving better integration with other open standards. The 3GPP LTE project is not itself a standard-generating effort, but will result in new recommendations for standards for the UMTS. Further developments in these areas are also referred to as Long Term Evolution-Advanced (“LTE-A”).

The evolved UMTS terrestrial radio access network (“E-UTRAN”) in 3GPP includes base stations providing user plane (including packet data convergence protocol/radio link control/medium access control/physical (“PDCP/RLC/MAC/PHY”) sublayers) and control plane (including radio resource control (“RRC”) sublayer) protocol terminations towards wireless communication devices such as cellular telephones. A wireless communication device or terminal is generally known as a user equipment (“UE”) or a mobile station (“MS”). A base station is an entity of a communication network often referred to as a Node B or an NB. Particularly in the E-UTRAN, an “evolved” base station is referred to as an eNodeB or an eNB. For details about the overall architecture of the E-UTRAN, see 3GPP Technical Specification (“TS”) 36.300, v8.5.0 (2008-05), which is incorporated herein by reference. The terms base station, NB, eNB and cell generally refer to equipment and/or areas that provide a wireless network interface in a cellular telephony system, and will be used interchangeably herein, and include cellular telephony systems under, for instance, the 3GPP standards.

Machine-to-machine (“M2M”) communications has become a major topic in recent discussions on wireless communication system applications. M2M communications can be used for many purposes such as for smart homes, smart metering, fleet management, remote healthcare, access network operation management, etc. In principle, M2M communications is an important step towards a future “Internet of things.” Cellular operators have shown interest in M2M communications due to the new business opportunities that are presented. As a result, M2M communications is now under active standardization work in 3GPP LTE discussions. In January 2009, the European Telecommunications Standards Institute (“ETSI”) started work in a new Technical Committee directed to machine-to-machine communication (ETSI TC M2M) to specify M2M requirements and to develop an end-to-end high-level architecture for M2M communication systems. In September 2009, the 3GPP Technical Subgroup for Radio Access Network (“TSG RAN”) opened a new Study Item on “RAN Improvements for Machine-type Communications.”

The number of emergency “911” calls placed by people in the United States (“U.S.”) using wireless communication devices has increased dramatically in recent years. Public safety personnel in the U.S. estimate that about 50 percent of the millions of 911 calls received daily are placed from wireless communication devices, and the percentage is growing. LTE-based voice services are expected to be deployed with LTE Release 9. An accurate wireless communication device positioning process will be needed to meet U.S. Federal Communication Commission (“FCC”) emergency 911 (“E911”) requirements related to handling emergency 911 calls, which state that an emergency call from the wireless communication device must be located within 50 meters for 67 percent of the calls, and within 150 meters for 95 percent of the calls.

In view of the growing utilization of the wireless communication devices and the importance of determining the location of a user communicating with a wireless communication device in an emergency situation, it is important to provide this capability in a communication system with reasonable costs to system operators and for the wireless communication device carried by a user. Therefore, what is needed in the art is an apparatus, system and method for providing the capability to determine the location of a wireless communication device in a communication system in an efficient and cost effective manner.

### SUMMARY OF THE INVENTION

These and other problems are generally solved or circumvented, and technical advantages are generally achieved, by embodiments of the present invention, which include an apparatus, system and method for determining a location of a wireless communication device (e.g., a user equipment) employing machine-to-machine devices in a communication system. In one embodiment, the apparatus (e.g., embodied in user equipment) includes a processor and memory including computer program code. The memory and the computer program code are configured to, with the processor, cause the apparatus to receive a list of machine-to-machine device identifiers for machine-to-machine devices, produce machine-to-machine measurement reports based of reference signals from the machine-to-machine devices on the list, and prepare the machine-to-machine measurement reports for transmission to a base station to determine a position of the apparatus.

In another aspect, the memory and the computer program code are configured to, with the processor, cause the apparatus (e.g., embodied in a base station) to compute a location estimate for a user equipment by performing an initial angle of arrival and timing advance location calculation therefor, and receive a list of machine-to-machine device identifiers for machine-to-machine devices dependent on the location estimate for transmission to the user equipment. The memory and the computer program code are further configured to, with the processor, cause the apparatus to enable resources for reference signals to be transmitted between the machine-to-machine devices and the user equipment for preparation of machine-to-machine measurement reports, and provide the machine-to-machine measurement reports received from the user equipment to a serving mobile location center to determine a position of the user equipment.

In yet another aspect, the memory and the computer program code are configured to, with the processor, cause the apparatus (e.g., embodied in a serving mobile location center) to construct a list of machine-to-machine device identifiers for machine-to-machine devices dependent on a location estimate for a user equipment, and prepare the list of machine-to-machine device identifiers for transmission to the user equipment. The memory and the computer program code are further configured to, with the processor, cause the apparatus to construct a refined location estimate for the user equipment based on machine-to-machine measurement reports dependent on reference signals from the machine-to-machine devices on the list at the user equipment.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the invention, and the advantages thereof, reference is now made to the following descriptions taken in conjunction with the accompanying drawings, in which:

FIGS. 1 and 2 illustrate system level diagrams of embodiments of communication systems including a base station and wireless communication devices that provide an environment for application of the principles of the present invention;

FIGS. 3 and 4 illustrate system level diagrams of embodiments of communication systems including a wireless communication systems that provide an environment for application of the principles of the present invention;

FIGS. 5 to 8 illustrate system level diagrams of embodiments of communication systems performing exemplary methods of determining a location of a wireless communication device according to the principles of the present invention; and

FIG. 9 illustrates a system level diagram of an embodiment of a communication element of a communication system constructed in accordance with the principles of the present invention.

### DETAILED DESCRIPTION OF ILLUSTRATIVE EMBODIMENTS

The making and using of the exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. In view of the foregoing, the present invention will be described with respect to exemplary embodiments in a specific context of an apparatus, system and method for determining the location of a wireless communication device in a wireless communication system or network. Although systems and methods described herein are described with reference to a 3GPP LTE cellular network, they can be applied to any communication system including a Global System for Mobile Communications (“GSM”) wireless communication network or to a WiMax™ wireless communication network.

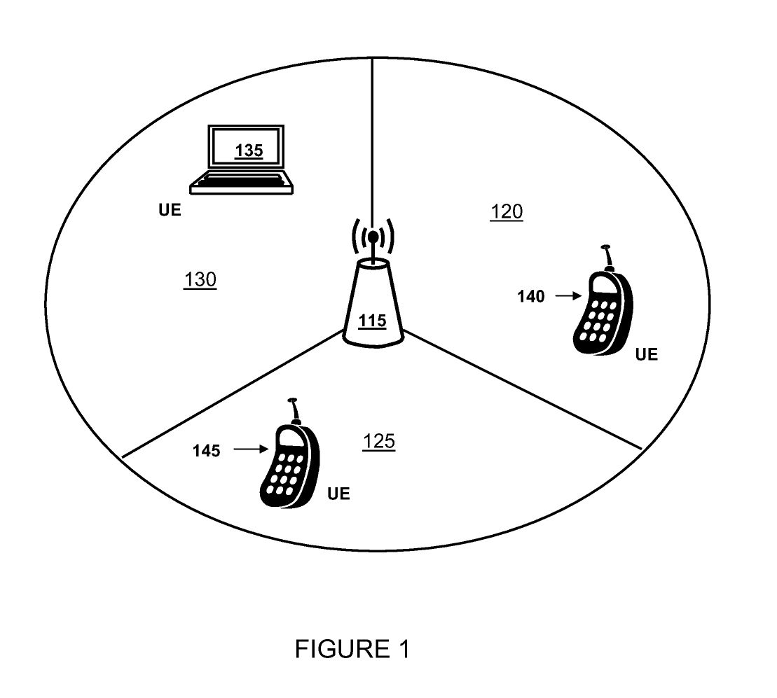

Turning now to FIG. 1, illustrated is a system level diagram of an embodiment of a communication system including a base station 115 and wireless communication devices (e.g., user equipment) 135, 140, 145 that provides an environment for application of the principles of the present invention. The base station 115 is coupled to a public switched telephone network (not shown). The base station 115 is configured with a plurality of antennas to transmit and receive signals in a plurality of sectors including a first sector 120, a second sector 125, and a third sector 130, each of which typically spans 120 degrees. Although FIG. 1 illustrates one wireless communication device (e.g., wireless communication device 140) in each sector (e.g., the first sector 120), a sector (e.g., the first sector 120) may generally contain a plurality of wireless communication devices. In an alternative embodiment, a base station 115 may be formed with only one sector (e.g., the first sector 120), and multiple base stations may be constructed to transmit according to collaborative/cooperative multiple-input multiple-output (“C-MIMO”) operation, etc. The sectors (e.g., the first sector 120) are formed by focusing and phasing radiated signals from the base station antennas, and separate antennas may be employed per sector (e.g., the first sector 120). The plurality of sectors 120, 125, 130 increases the number of subscriber stations (e.g., the wireless communication devices 135, 140, 145) that can simultaneously communicate with the base station 115 without the need to increase the utilized bandwidth by reduction of interference that results from focusing and phasing base station antennas.

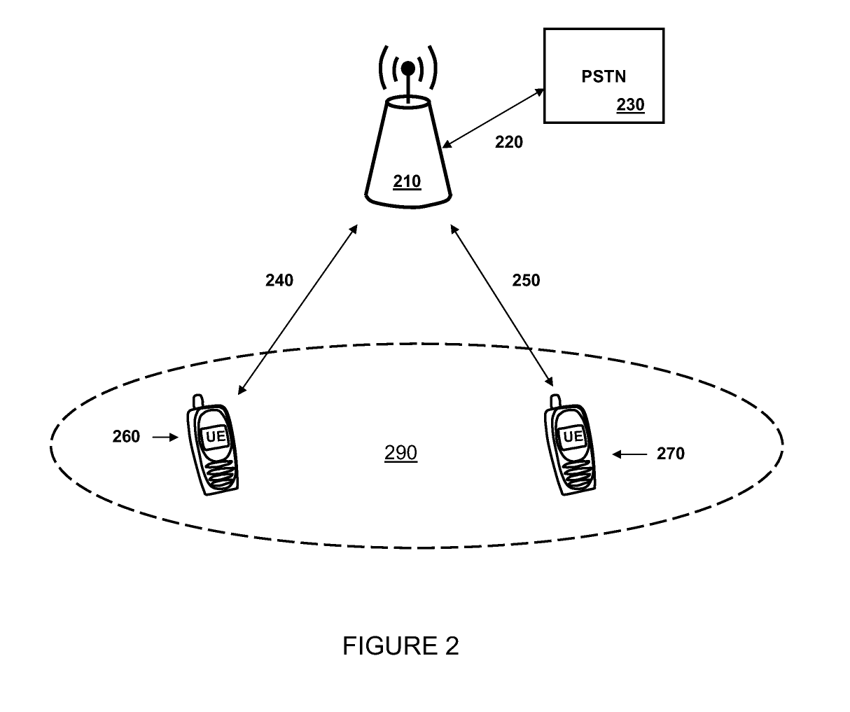

Turning now to FIG. 2, illustrated is a system level diagram of an embodiment of a communication system including a base station and wireless communication devices that provides an environment for application of the principles of the present invention. The communication system includes a base station 210 coupled by communication path or link 220 (e.g., by a fiber-optic communication path) to a core telecommunications network such as public switched telephone network (“PSTN”) 230. The base station 210 is coupled by wireless communication paths or links 240, 250 to wireless communication devices 260, 270, respectively, that lie within its cellular area 290.

In operation of the communication system illustrated in FIG. 2, the base station 210 communicates with each wireless communication device 260, 270 through control and data communication resources (or resources) allocated by the base station 210 over the communication paths 240, 250, respectively. The control and data communication resources may include frequency and time-slot communication resources in frequency division duplex (“FDD”) and/or time division duplex (“TDD”) communication modes.

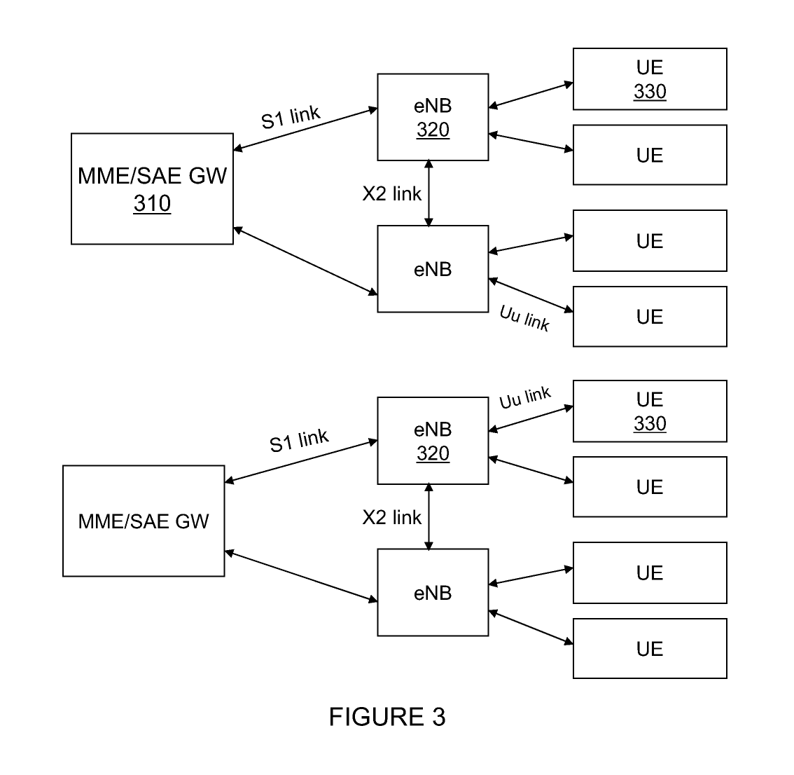

Turning now to FIG. 3, illustrated is a system level diagram of an embodiment of a communication system including a wireless communication system that provides an environment for the application of the principles of the present invention. The wireless communication system may be configured to provide evolved UMTS terrestrial radio access network (“E-UTRAN”) universal mobile telecommunications services. A mobile management entity/system architecture evolution gateway (“MME/SAE GW,” one of which is designated 310) provides control functionality for an E-UTRAN node B (designated “eNB,” an “evolved node B,” also referred to as a “base station,” one of which is designated 320) via an S1 communication link (ones of which are designated “S1 link”) The base stations 320 communicate via X2 communication links (ones of which are designated “X2 link”) The various communication links are typically fiber, microwave, or other high frequency metallic communication paths such as coaxial links, or combinations thereof.

The base stations 320 communicate with user equipment (“UE,” ones of which are designated 330), which is typically a mobile transceiver carried by a user. Thus, communication links (designated “Uu” communication links, ones of which are designated “Uu link”) coupling the base stations 320 to the user equipment 330 are air links employing a wireless communication signal such as, for example, an orthogonal frequency division multiplex (“OFDM”) signal.

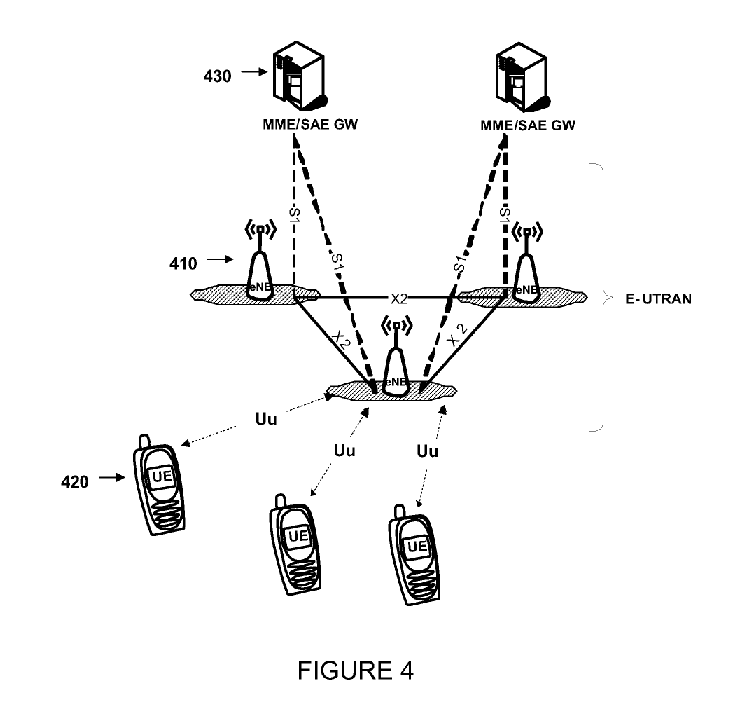

Turning now to FIG. 4, illustrated is a system level diagram of an embodiment of a communication system including a wireless communication system that provides an environment for the application of the principles of the present invention. The wireless communication system provides an E-UTRAN architecture including base stations (one of which is designated 410) providing E-UTRAN user plane (payload data, packet data convergence protocol/radio link control/media access control/physical sublayers) and control plane (radio resource control sublayer) protocol terminations towards user equipment (one of which is designated 420). The base stations 410 are interconnected with X2 interfaces or communication links (designated “X2”). The base stations 410 are also connected by S1 interfaces or communication links (designated “S1”) to an evolved packet core (“EPC”) including a mobile management entity/system architecture evolution gateway (“MME/SAE GW,” one of which is designated 430). The S1 interface supports a multiple entity relationship between the mobile management entity/system architecture evolution gateway 430 and the base stations 410. For applications supporting inter-public land mobile handover, inter-eNB active mode mobility is supported by the mobile management entity/system architecture evolution gateway 430 relocation via the S1 interface.

The base stations 410 may host functions such as radio resource management. For instance, the base stations 410 may perform functions such as internet protocol (“IP”) header compression and encryption of user signal streams, ciphering of user signal streams, radio bearer control, radio admission control, connection mobility control, dynamic allocation of resources to user equipment in both the uplink and the downlink, selection of a mobility management entity at the user equipment attachment, routing of user plane (also referred to as “U-plane”) data towards the user plane entity, scheduling and transmission of paging messages (originated from the mobility management entity), scheduling and transmission of broadcast information (originated from the mobility management entity or operations and maintenance), and measurement and reporting configuration for mobility and scheduling. The mobile management entity/system architecture evolution gateway 430 may host functions such as distribution of paging messages to the base stations 410, security control, termination of user plane packets for paging reasons, switching of user plane for support of the user equipment mobility, idle state mobility control, and system architecture evolution bearer control. The user equipment 420 receives an allocation of a group of information blocks from the base stations 410.

A method to perform user equipment positioning is to incorporate a global positioning system (“GPS”) module into the user equipment, and report GPS location of the user equipment to a communication network as described in 3GPP document RP-080995, entitled “Positioning Support for LTE,” 3GPP Work Item Description, RAN No. 44, dated December 2008, which is incorporated herein by reference. This is a user equipment-centric solution widely used for navigation and services such as Google Map™ and Nokia Ovi™ contact applications running on user equipment. However, there are several drawbacks of using GPS for user equipment positioning such as the GPS may not work in some indoor environments. A second drawback is that the GPS technology in the user equipment is expensive, and is typically available in user equipment such as smart mobile telephones. A third drawback is that the GPS presents excessive battery drain to the user equipment to keep track of a location thereof.

There are currently several communication-based solutions for user equipment positioning in 3GPP Release 9 as described in the 3GPP document RP-080995, cited previously hereinabove. The solutions include observed time difference of arrival (“OTDOA”), uplink (“UL”) time difference of arrival (“UTDOA”) and angle of arrival+timing advance (“AoA”+“TA”) based positioning. The first two solutions are expensive from a communication network viewpoint because of a requirement for accurate communication network synchronization. With respect to the third solution, workability is not clear due to the need for positioning accuracy, control signaling, and battery consumption issues at the user equipment.

The FCC E911 requirements in the U.S. state that the location of 67 percent of users be determined within 50 meters, which requires about five-sample accuracy with a sampling frequency of 32.72 Megahertz (“MHz”), and that the location of 95 percent of users be determined within 150 meters, which requires about 15-sample accuracy with a sampling frequency of 32.72 MHz. Such sampling processes may not be adequate in heavily populated areas.

An effective communication network-centric solution is thus needed to provide near-universal positioning coverage without impacting communication network or user equipment resources or user equipment battery drain. In OTDOA, the user equipment location is trilaterated (i.e., the location is established with three timing/distance measurements) with knowledge of transmit timing of the participating cells in the communication system and their geographical locations.

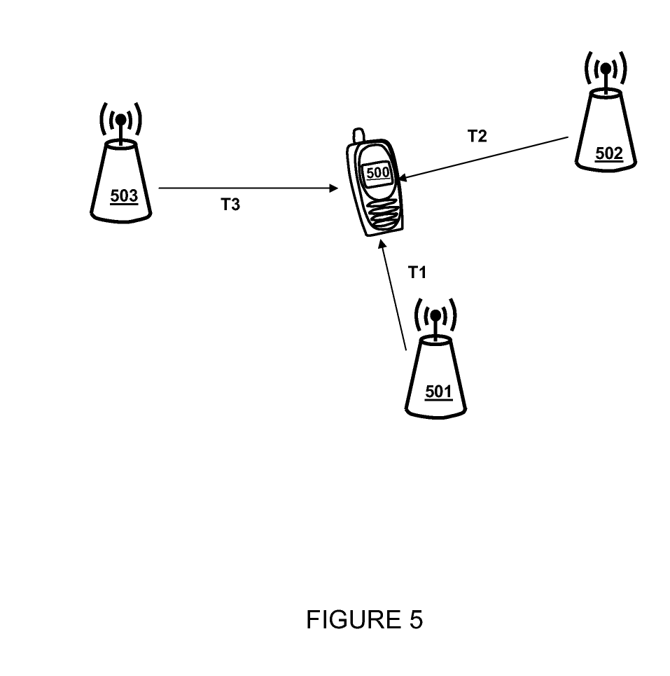

Turning now to FIG. 5, illustrated is a system level diagram of an embodiment of a communication system performing an exemplary method of determining a location of a wireless communication device according to the principles of the present invention. The exemplary method employs the observed time differences of arrival (“OTDOA”) to determine the location of the wireless communication device such as user equipment. Upon request, the user equipment 500 measures the observed time differences (“OTDs”) of neighboring base stations 502, 503 relative to a serving base station 501. The user equipment 500 reports to the serving base station 501 the observed time differences relative to the serving base station 501 timing based on transmit timing of signals from at least two other cells such as the neighboring base stations 502, 503, and their respective cell identifiers (“IDs”). Thus, if neighboring base station 502 represents cell 2, then the user equipment 500 transmits a measurement report of T1-T2 to the serving base station 501 for cell 2 with the cell identifiers, wherein T1 represents the timing of arrival of signals from the serving base station 501 and T2 represents the timing of arrival of signals from the neighboring base station 502. Similarly, if neighboring base station 503 represents cell 3, then the user equipment 500 transmits a measurement report of T1-T3 to the serving base station 501 for cell 3 with the cell identifiers, wherein T1 represents the timing of arrival of signals from the serving base station 501 and T3 represents the timing of arrival of signals from the neighboring base station 503.

A positioning reference signal (“PRS”) pattern has been established in 3GPP document R1-092213-WF on RAN1, by Ericsson, Alcatel-Lucent, Nokia, Nokia Siemens Networks, Qualcomm Europe, LG, Samsung, Huawei, Motorola, and Pantech & Curitel, entitled “WF on RAN1 Concept for OTDOA,” and in 3GPP document R1-092963 by Qualcomm on RAN1 No. 58Bis, entitled “PRS Pattern design,” dated August 2009, which documents are incorporated herein by reference. The OTDOA requires microsecond-level communication network synchronization, which is an expensive technology that uses either (i) GPS (field-proven code division multiple access (“CDMA”) 2000 base transceiver station (“BTS”) 1xRTT advanced forward link trilateration (“AFLT”) with synchronization accuracy of ±3 microseconds (“μs”)); or (ii) IEEE Standard 1588 for precision clock synchronization, wherein base stations measure round-trip timing (“RTT”) to local routers, and iteratively adjust their clock timings in a coordinated fashion. The OTDOA is a 3GPP Release 9 feature for compatible user equipment. Thus, for an OTDOA arrangement to operate, the timing and reporting capabilities are installed in user equipment and base stations.

As distinct from OTDOA processes, UTDOA determines the location of the user equipment employing location measurement units (“LMUs”) that are typically colocated with the base stations to measure time differences of arrival between a signal arriving at a serving cell and a cooperating cell, as described in 3GPP document R1-092998, entitled “Results for UTDOA Positioning Simulations,” TruePosition, RAN1#58, dated August 2009, which is incorporated herein by reference. As described below, the UTDOA observes time differences of arrival at several base stations to determine the location of a user equipment.

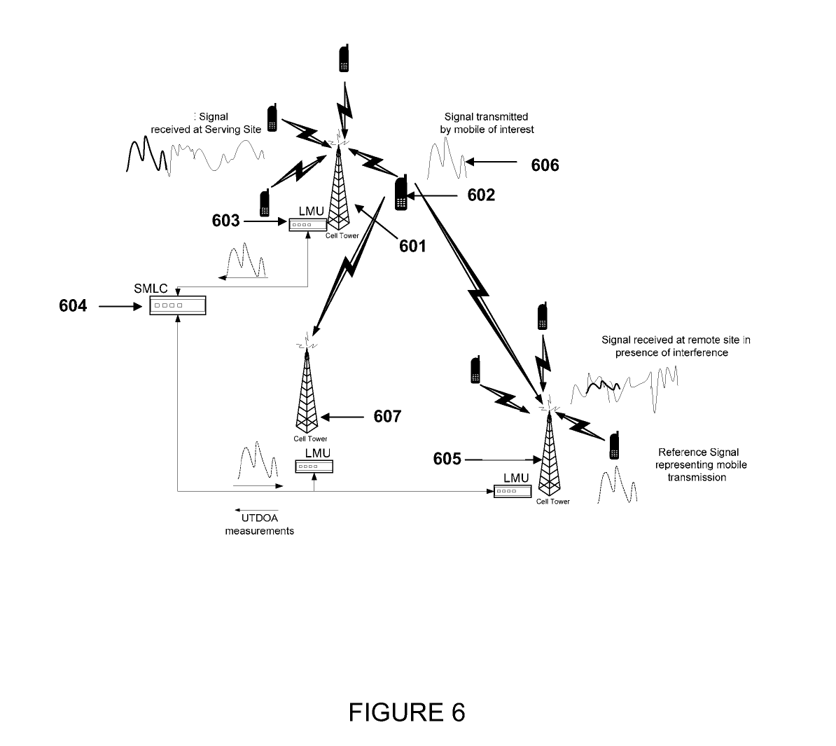

Turning now to FIG. 6, illustrated is a system level diagram of an embodiment of a communication system performing an exemplary method of determining a location of a wireless communication device according to the principles of the present invention. The exemplary method employs the uplink time difference of arrival (“UTDOA”) to determine the location of the wireless communication device such as user equipment. A serving base station 601 communicates over a serving area with user equipment such as user equipment 602. Other base stations such as base stations 605, 607, are also able to receive a signal transmitted from the user equipment 602. A location measurement unit (“LMU”) is located at each base station such as LMU 603 located at the serving base station 601. In operation, the user equipment 602, whose location is to be determined, transmits a signal 606. The signal 606 is received at the serving base station 601 and other base stations such as base stations 605, 607. The LMU at each base station (see, e.g., LMU 603 at the serving base station 601) coordinates a timing signal with a serving mobile location centre (“SMLC”) 604 to enable the SMLC 604 to estimate the location of the user equipment 602 from the uplink time differences of arrival of the signal 606 transmitted from user equipment 602. The LMU 603 establishes a timing reference by employing a signal received from GPS satellites.

The LMU 603 performs both a detection function for obtaining a reference signal as well as a cross-correlation function for obtaining UTDOA measurements. For the UTDOA, the LMUs 603 are Type B LMUs that are synchronized using GPS as described in 3GPP Technical Specification 43.059 entitled “Functional Stage 2 Description of Location Services (LCS) in GERAN,” V8.1.0, which is incorporated herein by reference. The LMU 603 portion of the communication network may either be synchronized independently or with a base station when using synchronous operations. The UTDOA typically does not employ user equipment assistance as described in 3GPP document RP-090354, entitled “Network-Based Positioning Support for LTE,” 3GPP Work Item Description, RAN43, dated March 2009, which is incorporated herein by reference, but again may employ microsecond-level communication network synchronization and hardware technology.

An AoA+TA based positioning method as described in 3GPP document R1-091595, entitled “Performance of UE Positioning Based on AoA+TA,” China Academy Telecommunication Technology (“CATT”), Research Institute of Telecommunications Transmission (“RITT”), RAN1 No. 56bis, which is incorporated herein by reference, was agreed by the 3GPP RAN1 work group as a feasible solution for 3GPP Release-9 positioning, as described in 3GPP document R1-092282, entitled “LS on AoA+TA positioning,” RAN1#57, dated May 2009, which is incorporated herein by reference.

In angle of arrival+timing advance (“AoA+TA”), a base station estimates the current absolute uplink timing advance of a user equipment based on dedicated physical random access channel (“PRACH”) transmissions from the user equipment over a positioning measurement interval. To estimate the AoA, the base station may use sounding reference signals (“SRSs”) or other uplink reference signal transmitted by the user equipment. Positioning accuracy depends on the accumulated user equipment timing errors on the PRACH detection and AoA accuracy. If the holding time is long and the user equipment receives many timing advance commands, the positioning accuracy may significantly deteriorate. It was proposed in 3GPP document R1-093090, by NTT DoCoMo, entitled “UE Positioning Based on Propagation Delay,” RAN1 No. 58, dated August 2009, which is incorporated herein by reference, to specify the positioning accuracy of new user equipment measurement reports to improve positioning accuracy. The impact on uplink signaling on a random access channel (“RACH”) and the sounding reference signals or uplink demodulation reference signals may become a problem for the tracking of user equipment location resulting from too many uplink transmissions and will involve an unacceptable battery drain at the user equipment.

As introduced herein, a base station performs an initial angle of arrival+timing advance location process for a user equipment and reports the location to an enhanced serving mobile location centre (“eSMLC”). The eSMLC then signals to the base station a list of M2M device identifiers (“IDs”) of fixed M2M devices close to the initial user equipment location. Recall that M2M devices are wireless devices targeted at applications such as automated metering, telematics, security, and electronic point of sale, and are thus expected to be widely distributed across an urban area, and generally relatively close to the user equipment. The base station forwards the list of M2M device IDs to the user equipment and provides signaling resources (via reference signal transmissions) to the user equipment and to the M2M devices in the list. The user equipment detects broadcasted reference signals from the M2M devices in the list of M2M device IDs and reports the measurements to the base station to assist with the positioning thereof in the eSMLC.

The M2M measurement reports from the user equipment may include (i) the observed time difference (“OTD”) between the estimated M2M reference signal timing and the estimated downlink base station timing at the user equipment; (ii) the estimated M2M reference signal encompassing a signal-to-interference and noise ratio (“SINR”) at the user equipment; and (iii) the M2M device ID. The M2M measurement reports may be used by the eSMLC to determine the user equipment position employing the following criteria. In criterion (i), if the OTDi for the i^{th} M2M device is less than a minimum propagation delay representing a minimum positioning accuracy and the SINRi (i.e., the SINR for the i^{th} M2M device) is greater than a threshold SINRo for the list of M2M devices, then the user equipment location is set to that of the M2M device number i. In criterion (ii) and assuming criterion (i) cannot be met, if OTDk is less than a maximum propagation delay and if SINRk is greater than a threshold SINRmin for a subset of M2M devices in the list (k=1, 2, . . . , K), then the user equipment location can be trilaterated based on (a) OTDs of at least two M2M devices and the base station or, alternatively, based on (b) OTDs of at least three M2M devices without use of OTD from the base station to allow tracking of the user equipment movements.

In large cells wherein M2M device synchronization may not be assumed, the eSMLC may use the M2M measurement reports of a subset in the list (j=1, 2, . . . , J) to compute an average of the angle of arrival of the user equipment using the angle of arrival of each M2M device stored in the eSMLC database. Criteria (i) and (ii) may be employed by the eSMLC to select the M2M devices whose angle of arrivals will be used for the average angle of arrival computation. The M2M-based angle of arrival and the timing advance of the user equipment are then used in the eSMLC to determine the user equipment position.

In populated areas wherein the availability of fixed M2M devices is higher and when base station estimated delay of arrival (“DoA”) accuracy is poor, the M2M measurement report may be used to estimate the angle of arrival of the user equipment and use the same with the timing advance to determine the user equipment location. If the user equipment can report measurements from more than one fixed M2M device, the M2M-based delay of arrival accuracy may be improved.

The position of the fixed M2M devices in a cell is generally known to the eSMLC with sufficient accuracy. M2M device broadcasting uses low power for short range transmissions. The eSMLC may use the measurement reports and the timing advance sent by the base station to the user equipment to determine the location of the user equipment. Nearby M2M devices acting as anchors for positioning may help pinpoint the location of a user equipment potentially with a higher accuracy than that specified in FCC E911 requirements. M2M device assisted positioning at the base station can be performed as hereinafter described using an initial angle of arrival+timing advance user equipment location.

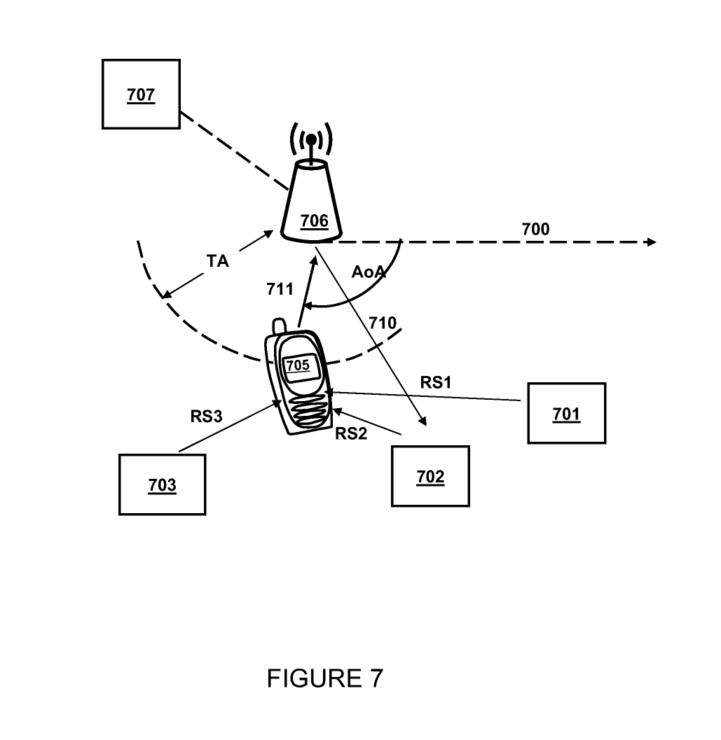

Turning now to FIG. 7, illustrated is a system level diagram of an embodiment of a communication system performing an exemplary method of determining a location of a wireless communication device according to the principles of the present invention. In particular, the communication system includes M2M devices 701, 702, 703, a user equipment 705, a base station 706, and an eSMLC 707 and provides for the positioning of the user equipment 705 employing an observed time differences between the user equipment 705 and the M2M devices 701, 702, 703 and an angle of arrival (designated “AoA”) of an uplink signal 711 by the user equipment 705 arriving at the base station 706. A reference for the geographic direction is represented by a line 700.

The base station 706 transmits a downlink signal (e.g., a downlink cellular signal 710) to the M2M devices 701, 702, 703. The M2M devices 701, 702, 703 broadcast short-range reference signals RS1, RS2, RS3 to produce observed time differences OTD1, ORD2, OTD3, respectively, with the user equipment 705. The user equipment 705 uses long-range wireless transmissions to communicate an M2M measurement report to the base station 706 including the reference signal based measurements that provide the detection range of the user equipment 705 to the M2M devices 701, 702, 703.

In general, an M2M device (e.g., M2M device 701) may be synchronized to the base station 706 to align downlink timing thereto. Since the user equipment 705 also aligns the downlink timing to the base station 706, the M2M device (e.g., M2M device 701) is approximately synchronized to the user equipment 705 (e.g., for reception from the base station 706 and transmission to the user equipment 705 using downlink resources in a time division duplex (“TDD”) mode). The M2M device (e.g., M2M device 701) may be synchronized to the base station 706 to receive radio resource control (“RRC”) configuration and media access control (“MAC”) signaling for a downlink slot allocation (e.g., control data for operational parameters), and an uplink slot allocation for broadcasting of position reference signals (e.g., reference signal RS1) to the user equipment 705 using downlink resources. Assuming the M2M device (e.g., M2M device 701) is typically within 100 meters from the user equipment 705, the maximum propagation delay is around 0.33 microsecond (“μs”), which is a fraction of a cyclic prefix when a LTE-A compatible communication system is used for the short-range transmission. The downlink timing for the user equipment 705 may be based, for example, on the base station 706 primary and secondary synchronization channels (“P-SCH” and “S-SCH”) and cell-specific reference signals (“CRS”) as specified in 3GPP LTE Technical Specification 36.211, entitled “Technical Specification Group Radio Access Network; Evolved Universal Terrestrial Radio Access (E-UTRA); Physical Channels and Modulation (Release 8),” dated September 2009, which is incorporated herein by reference.

A timing advance (designated “TA”) is signaled to the user equipment 705 by the base station 706 based on measurements at the base station 706 during the uplink transmission of the RACH signal by the user equipment 705. The timing advance parameter allows the base station 706 to know within a 16xTs (0.5 μs or about 160 meters) accuracy the distance between the user equipment 705 and the base station 706 along a line of sight (“LOS”). The eSMLC 707 signals to the user equipment 705 via the base station 706 a list of M2M device IDs of the M2M devices 701, 702, 703 close to the initial location of the user equipment 705 based on an initial AoA+TA user equipment location estimate by the base station 706. The base station 706 may indicate by MAC signaling to the user equipment 705 and the M2M devices 701, 702, 703 resources for the reference signal RS1, RS2, RS3 transmissions by the M2M devices 701, 702, 703. The user equipment 705 may then attempt to measure the broadcasted reference signals RS1, RS2, RS3 by the M2M devices 701, 702, 703, respectively.

The M2M measurement reports may indicate the M2M device ID, the observed time differences between the estimated M2M reference signal timing and the estimated downlink base station 706 timing at the user equipment 705, and some level of confidence based on an M2M reference signal received metric (e.g., detected M2M reference signal SINR). The observed time difference corresponds to the propagation delay between an M2M device (e.g., M2M device 701) and the user equipment 705. Knowing the (i) timing advance of the user equipment 705, (ii) the location of the M2M devices 701, 702, 703, and (iii) the measurements indicated in the M2M measurement reports for the M2M devices, 701, 702, 703, (e.g., OTD1-OTD3 and SINR1-SINR3 for M2M devices 701, 703), the eSMLC 707 may accurately determine the location of the user equipment 705. The M2M devices 701, 702, 703 act as position references for positioning the user equipment 705.

The accuracy of the M2M-based positioning depends on the availability of nearby M2M devices (e.g., M2M devices 701, 703) acting as anchors. If there are several such M2M anchors, it may be possible to significantly increase positioning accuracy by means of a weighted averaging of, for instance, the OTD1-OTD3 and SINR1-SINR3 for M2M devices 701, 703. For example, in criterion (i) introduced above, assume the smallest OTDi is less than a minimum propagation delay corresponding to a distance of 50 meters, and SINRi is greater than the threshold SINRo for an M2M device i=3 in the list. Then the location of the user equipment 705 may be set to that of the M2M device 703. In another example, in step (ii) mentioned above, assume OTDk is less than a maximum propagation delay and SINRk is greater than SINRmin for M2M devices 701, 703. Then the location of the user equipment 705 is set to a weighted average of the locations of M2M devices 701, 703 as the subset of M2M devices based on OTD1, OTD3 and SINR1, SINR3, respectively. Further assume that the observed time difference of M2M device 702 is discarded because it does not meet criterion (ii) mentioned above.

The SINR may be estimated simply by detecting the reference signal correlation peak-to-noise ratio at the output of a sliding reference signal correlation detector of a processor. A value of SINRmin=3 decibels (“dB”) and SINRo=5 dB could be used to determine “noisy” M2M reference signal transmissions. In this example, if criterion (i) applies or if criterion (ii) applies, an average observed time difference for the user equipment 705 could be simply determined as:

step (i): OTD=OTD3

step (ii): OTD=trilateration(OTD1, OTD3, OTDeNB),

wherein OTD1 and OTD3 are the observed time differences with the M2M devices 701, 703, respectively, and OTDeNB is the observed time difference with the base station 706.

The trilateration function may be performed in a conventional way using timing differences of signals representing distances between three known locations. The eSMLC 707 has knowledge of (a) transmit timings of the M2M devices 701, 703, the serving base station 706, and their collective geographical locations; and (b) the observed time differences of at least two M2M devices (e.g., M2M devices 701, 703) and the serving base station 706. As the M2M devices 701, 703 obtain their transmit timing from the serving base station 706, the trilateration procedure or algorithm should include a fixed offset to compensate for the propagation delay between the M2M devices 701, 703 and the serving base station 706. Alternatively, the observed time differences of at least three M2M devices 701, 702, 703 may be employed without the need for the observed time difference of the serving base station 706. As the M2M devices 701, 702, 703 are close to each other, the transmit timings may be assumed to be the same. Hence, there is no need for an offset. The use of at least three M2M devices 701, 702, 703 allows simpler tracking of user equipment 705 movements. The observed time difference of the base station 706 requires measurements by the base station 706 from reference signals transmitted by the user equipment 705 on the uplink.

The M2M devices 701, 702, 703 used as anchors could typically be fixed smart meters or boilers in a residence equipped with, for example, a wide-area downlink LTE connection and an uplink LTE local area (“LA”) connection. These M2M devices 701, 702, 703 may receive user commands for normal operations on the downlink. A nearby user may collect normal operation data (e.g., a meter reading, ambient temperature) using a downlink LTE local area connection. Hence, as introduced herein, subframes with M2M-based reference signals could readily be scheduled by a base station 706 to the M2M devices 701, 702, 703 on a MAC-configured downlink LTE local area resources. Other types of fixed M2M devices 701, 702, 703 may be employed. A future Internet-of-Things may connect many machines. The location of the machines may be fixed (e.g., smart electricity meters in a residence, closed-circuit television (“CCTV”) surveillance cameras, speed-limit detectors) or connected to the communication network within a few meters of an Internet access point. M2M-assisted positioning can be performed as hereinafter described using angle of arrival and timing advance using an initial AoA+TA user equipment location by a base station.

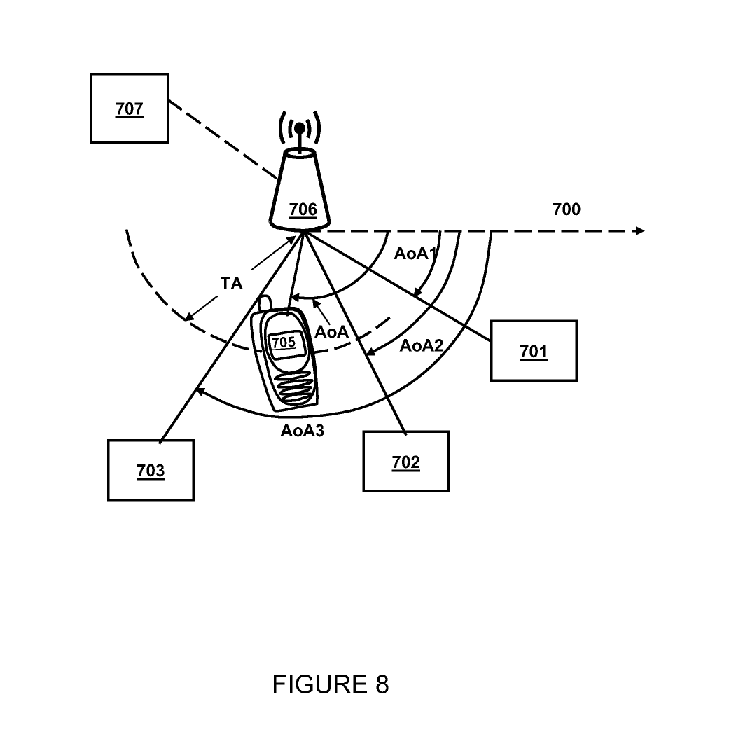

Turning now to FIG. 8, illustrated is a system level diagram of an embodiment of a communication system performing an exemplary method of determining a location of a wireless communication device according to the principles of the present invention. For purposes of simplicity, analogous parameters and elements of the communication system of present embodiment are designated with like reference designations to the communication system illustrated and described with respect to FIG. 7. In particular, the communication system includes M2M devices 701, 702, 703, a user equipment 705, a base station 706 and an eSMLC 707. The communication system employs M2M measurement reports for angle of arrival (designated “AoA”) estimation to estimate the position of the user equipment 705. A reference for the geographic direction is represented by a line 700.

The communication system employs angles of arrivals designated AoA1, AoA2, AoA3 corresponding to reference signals from the M2M devices 701, 702, 703, respectively, arriving at the base station 706. The modes of operation between the M2M devices 701, 702, 703, the user equipment 705, the base station 706 and the eSMLC 707 are analogous to the M2M-assisted positioning using an initial AoA+TA user equipment 705 location at the base station 706. The main difference is that after determination of an initial base station 705 estimated AoA+TA user equipment 705 location, the eSMLC 707 may use the angles of arrival AoA1, AoA2, AoA3 of each of the M2M devices 701, 702, 703, respectively, to estimate a new angle of arrival for the user equipment 705, which can then be used for a new AoA+TA user equipment 705 location estimation. Using the M2M devices 701, 702, 703 for angle of arrival estimation will save user equipment 705 battery consumption, base station 706 PRACH resources and sounding reference signal (“SRS”) or other reference signal (“RS”) resources. The user equipment 705 transmits on the uplink (i) PRACH for the initial timing advance determination, and (ii) sounding reference signal or other reference signal for the initial angle of arrival determination.

Knowing the location of the M2M devices 701, 702, 703 and that of the base station 706, the angles of arrival AoA1, AoA2, AoA3 may readily be obtained by (i) selecting the best M2M device anchor, or (ii) an average of the angles of arrival AoA1, AoA2, AoA3 based on SINR1, SINR2, SINR3 associated with the M2M devices 701, 702, 703, respectively. The intersection of the circle with radius timing advance and the straight line angle of arrival AoA in FIG. 8 gives the user equipment 705 location. In the example above, the angle of arrival of the user equipment 705 may be obtained from the angles of arrival AoA1, AoA2, AoA3 of the M2M devices 701, 702, 703 as:

step (i) AoA=AoA3, or

step (ii) AoA=(AoA1+AoA3)/2.

The angle of arrival AoA2 of the M2M device 702 was discarded because the corresponding OTD2 and SINR2 did not meet criterion (i) previously described above. If there is scarce availability of M2M devices 701, 702, 703, the communication system may use another base station-based angle of arrival estimate in an implementation as described below. The another base station-based angle of arrival estimate may be suitable for larger cells wherein the relative M2M device 701, 702, 703 propagation delays may have some impact on trilateration accuracy. The M2M devices 701, 702, 703 are typically not synchronized to one another, but obtain their synchronization parameters from the serving base station 706. The M2M devices 701, 702, 703 can be assumed to be sufficiently synchronized if the M2M devices 701, 702, 703 are physically close to each other.

In general and in the environment of the embodiments described herein, the measurement of the timing advance by the base station based on the user equipment RACH can be performed as set forth below. In a 3GPP LTE-based communication system, a timing advance is obtained during initial base station-cell access by the user equipment using a contentious RACH. The timing advance may also be obtained during the uplink transmit timing alignment procedure using a non-contentious RACH, as described in 3GPP Technical Specification 36.321 entitled “Evolved Universal Terrestrial Radio Access (E-UTRA) Medium Access Control (MAC) Protocol Specification (Release 9)” dated September 2009, and Technical Specification 36.331 entitled “Evolved Universal Terrestrial Radio Access (E-UTRA) Radio Resource Control (RRC); Protocol specification (Release 9),” which documents are incorporated herein by reference.

A base station accumulates timing advance commands (“Tadv”) sent to the user equipment after a successful random access process using the equation:

$$Tadv = ( {NTA}_{0} + {\sum }_{k} {NTA}_{k} ) \cdot 16 {T}_{s}$$

and measures the uplink propagation delay (“PDUL”) as described in 3GPP document R1-091595, cited previously above to compute a revised propagation delay:

Propagation delay=Tadv+PDUL,

where:
NTA₀ is the timing advance at the random access process,
NTAₖ are the successive timing advance commands, and
Tₛ is a subframe period.

The measurement of angle of arrival by the base station based on user equipment sounding reference signals or other reference signals can be performed as now described. A base station may obtain the channel matrix of antenna array from the sounding reference signals or other uplink reference signals as described in 3GPP LTE Technical Specification 36.211, cited previously, and then the angle of arrival of the uplink signal can be estimated based on grid of beam (“GOB”) method or eigenvalue (e.g., a singular value) obtained from singular value decomposition (“SVD”) of the uplink signal. The angle of arrival can be obtained iteratively within multiple subframes for best performance, as described in 3GPP document R1-091595, cited previously.

Alternatively, the base station may use knowledge of locations of M2M devices synchronized with a user equipment (via M2M measurement reports sent by the user equipment to a base station) to determine the angle of arrival of the user equipment. A cellular angle of arrival procedure may be performed at the base station assuming: (1) the user equipment may synchronize to reference signals broadcasted by nearby M2M devices, or (2) the angle of arrival for each M2M device relative to the base station are known at the base station. Regarding the second assumption above, the base station does not have to estimate the angle of arrival of each M2M device. Knowing the location of the M2M devices and that of the base station, the communication system can determine the angle of arrival in a less complex manner. The angle of arrival of the user equipment may be estimated by a weighted average of the angles of arrival of the M2M devices. The weighting function could take into account the measured M2M reference signal levels at the user equipment and reported to the base station by the user equipment.

The M2M device reference signal pattern, overhead, and scheduling may be employed when determining the location of a user equipment as set forth below. The selected M2M device reference signal patterns should ensure orthogonal M2M device reference signal transmissions from M2M devices in close proximity. The base station should mute its own transmissions during the M2M device reference signal transmission in a scheduled M2M device subframe, for example, by configuring the subframe as a multicast broadcast single frequency network (“MBSFN”) subframe. The process for the M2M device reference signals is similar to base station muting its transmission using an MBSFN configuration when neighboring base stations transmit positioning reference signals in OTDOA. The periodicity of the M2M device subframes may be low and scheduled by base station semi-persistent scheduling. As in OTDOA subframes specified in 3GPP Technical Specification 36.211, cited previously, the periodicity of M2M device subframes may be 160 milliseconds (“ms”), 320 ms, 640 ms, or 1280 ms with 1, 2, 3, 4, 8 consecutive subframes as described in 3GPP document R4-093400, “OTDOA Positioning Studies in RAN4: Updated Proposal on System Simulation”, RAN4#52, dated August 2009, which is incorporated herein by reference. This will help keep M2M device resources low. As M2M device reference signal transmissions are essentially short range and low power, such as an intended range of 150 meter or less transmitted with low power, M2M device reference signals re-use may be high or physical resource block (“PRB”) resources in the M2M device subframe may be set aside for data packet transmissions (e.g., M2M smart reader data, sensor data, etc.)

A few considerations for the implementation of M2M-based positioning are set forth below. It would be advantageous to know the location of the M2M devices acting as M2M anchors for the positioning. This may depend on, for instance, where the user locates the M2M device in the home (e.g., a smart electricity meter) or how the Internet protocol (“IP”) communication network provides location assistance (e.g., a network-connected laptop or access point). It may be beneficial to perform a one-time GPS measurement and log the GPS co-ordinates in a database for the location of the M2M devices with wireless modules (e.g., wireless modules compatible with LTE or LTE-A based communication systems). The database may be shared with communication network operators (e.g., LTE, LTE-A network operators), who can then readily use the M2M devices for positioning using processes introduced herein.

The M2M devices may perform self-synchronization using primary and secondary synchronization channels and cell-specific reference signals transmitted by a base station. The M2M device locations may be logged in the eSMLC database. With M2M device locations and M2M device positioning reference signal measurements, the eSMLC can determine the user equipment position. The M2M device location may be determined based on the address of the house or entity where the M2M devices are located (e.g., a smart electricity reader in the home). The M2M device location accuracy may typically be within a few tens of meters depending on the house/building size.

Regarding the eSMLC, the M2M measurement reports are specified in 3GPP LTE R9 in Technical Specification 36.355 entitled “Evolved Universal Terrestrial Radio Access (E-UTRA); LTE Positioning Protocol (LPP) (Release 9),” dated September 2009, and 3GPP Technical Specification 36.305, entitled “Evolved Universal Terrestrial Radio Access Network (E-UTRAN); Stage 2 Functional Specification of User Equipment (UE) Positioning in E-UTRAN,” dated September 2009. These two documents are incorporated herein by reference. The enhanced cell ID positioning (“E-CID”) measurement information currently includes the following.

E-CID Signal Measurement Information Field Descriptions

plmn-Identity
This field identifies the public land mobile network (“PLMN”)
measuredResultsList
This list contains the E-CID measurements for up to 32 cells.
physCellId
This field specifies the physical cell identity of the measured cell.
cellGlobalId
This field specifies cell global ID of the measured cell.
arfcnEUTRA
This field specifies the absolute radio frequency channel mumber
(“ARFCN”) of the measured E-UTRA carrier frequency
rsrpResult
This field specifies the reference signal received power (“RSRP”)
measurement rsrqResult
This field specifies the reference signal received quality (“RSRQ”)
measurement ueRxTxTimeDiff
This field specifies the user equipment receive - transmit (“Rx-Tx”) time
difference measurement, as defined in 3GPP document RP-080995, cited
previously

The eSMLC may also employ M2M-based reference signal time difference (“RSTD”) measurements to assist in the location of the user equipment.

Thus, as introduced herein, user equipment positioning is performed without a need for a GPS module in the user equipment or synchronization technology. Higher accuracy can be advantageously obtained than specified in FCC E911 requirements for user equipment positioning when nearby M2M devices are available to act as anchors for the user equipment positioning. Life-saving help can be summoned more quickly in an emergency call. The use of only M2M device reference signal measurements conserves user equipment battery energy and base station PRACH resources, and sounding reference signal or reference signal resources on the uplink. An improved angle of arrival and timing advance user equipment location process can be performed in large cells where M2M device synchronization cannot be assumed.

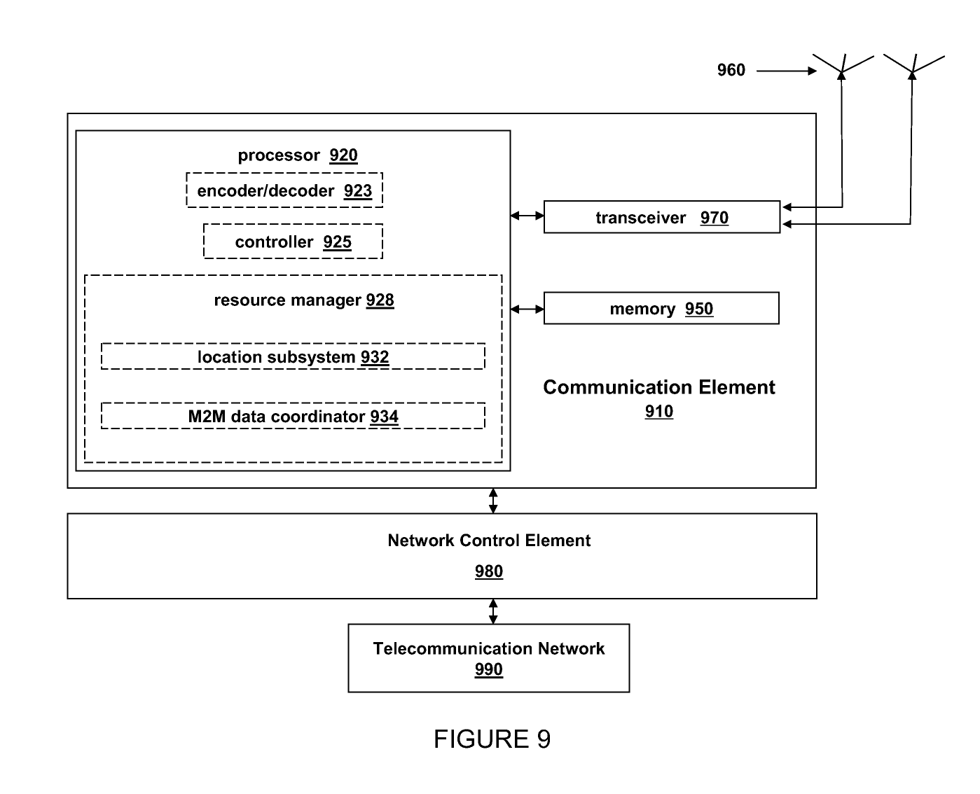

Turning now to FIG. 9, illustrated is a system level diagram of an embodiment of a communication element 910 of a communication system constructed in accordance with the principles of the present invention. The communication element or device 910 may represent, without limitation, a base station, a wireless communication device (e.g., user equipment, a subscriber station, a terminal, a mobile station, a wireless communication device), a network control element, a local area support node, an SMLC (or eSMLC), a machine-to-machine device, or the like. The communication element 910 includes, at least, a processor 920 and memory 950 that stores programs and data of a temporary or more permanent nature. The communication element 910 may also include a radio frequency transceiver 970 coupled to the processor 920 and a plurality of antennas (one of which is designated 960). The communication element 910 may provide point-to-point and/or point-to-multipoint communication services.

The communication element 910, such as a base station in a cellular network, may be coupled to a communication network element, such as a network control element 980 coupled to a public switched telecommunication network 990 (“PSTN”). The network control element 980 may, in turn, be formed with a processor, memory, and other electronic elements (not shown). The network control element 980 generally provides access to a telecommunication network such as a PSTN. Access may be provided using fiber optic, coaxial, twisted pair, microwave communication, or similar link coupled to an appropriate link-terminating element. A communication element 910 formed as user equipment is generally a self-contained device intended to be carried by an end user.

The processor 920 in the communication element 910, which may be implemented with one or a plurality of processing devices, performs functions associated with its operation including, without limitation, encoding and decoding (encoder/decoder 923) of individual bits forming a communication message, formatting of information, and overall control (controller 925) of the communication element 910, including processes related to management of resources represented by resource manager 928. Exemplary functions related to management of resources include, without limitation, hardware installation, traffic management, performance data analysis, tracking of end users and equipment, configuration management, end user administration, management of user equipment, management of tariffs, subscriptions, and billing, accumulation and management of characteristics of a local area network, and the like.

When the communication element 910 is formed as a base station, the memory 950 and computer program code is configured to, with the processor 920, perform an initial angle of arrival and timing advance location calculation for a user equipment to provide a location estimate therefor, report the location estimate to an SMLC, receive from the SMLC a list of M2M device identifiers of M2M devices based on the location estimate, enable the list to be transmitted to the user equipment, enable resources for a reference signal transmission between the user equipment and the M2M devices, and forward M2M measurement reports received from the user equipment to the SMLC. In one embodiment, the resource manager 928 of the processor 920 includes a location subsystem 932 configured to perform an initial angle of arrival and timing advance location calculation for a user equipment to provide a location estimate therefor and report the location estimate to an SMLC. The resource manager 928 also includes M2M data coordinator 934 configured to receive from the SMLC a list of M2M device identifiers of M2M devices based on the location estimate, enable the list to be transmitted to the user equipment, enable resources for a reference signal transmission between the user equipment and the M2M devices, and forward M2M measurement reports received from the user equipment to the SMLC. The M2M measurement report may include an observed time difference between estimated M2M reference signal timing and estimated downlink base station timing at the user equipment, an estimated M2M reference signal SINR at the user equipment, and M2M device identifiers. Additionally, the initial angle of arrival may be determined based on a grid of beams method or an eigenvalue obtained from a singular value decomposition of an uplink signal received from the user equipment. The initial angle of arrival may also be determined based on M2M measurement reports received from the user equipment and locations of the M2M devices.

When the communication element 910 is formed as a user equipment, the memory 950 and computer program code is configured to, with the processor 920, receive a list of M2M devices from a base station, produce M2M measurement reports based on reference signals received from the M2M devices on the list, and enable transmission of the machine-to-machine measurement reports to the base station. In one embodiment, the resource manager 928 of the processor 920 includes a M2M data coordinator 934 configured to receive a list of M2M devices from a base station, and produce M2M measurement reports based on reference signals received from the M2M devices on the list. The resource manager 928 is thereafter configured to enable transmission of the machine-to-machine measurement reports to the base station. The M2M measurement report may include an observed time difference between estimated M2M reference signal timing and estimated downlink base station timing at the user equipment, an estimated M2M reference signal SINR at the user equipment, and a M2M device identifier. Additionally, the estimated M2M reference signal SINR at the user equipment may be determined by detecting a reference signal correlation peak-to-noise ratio at an output of a sliding reference signal correlation detector of a processor.

When the communication element 910 is formed as an SMLC (or eSMLC), the memory 950 and computer program code is configured to, with the processor 920, receive an initial location estimate for a user equipment from a base station, construct a list of machine-to-machine devices based on the initial location estimate for transmission to the base station, receive M2M measurement reports from the base station, and construct a refined location estimate for the user equipment. In one embodiment, the resource manager 928 of the processor 920 includes a M2M data coordinator 934 configured to receive an initial location estimate for a user equipment from a base station, and construct a list of machine-to-machine devices based on the initial location estimate for transmission to the base station. The resource manager 928 also includes a location subsystem 932 configured to receive M2M measurement reports from the base station and construct a refined location estimate for the user equipment. The location subsystem 932 may construct the refined location estimate based on a location of a first M2M device from the M2M devices if an observed time difference of arrival of a reference signal at the user equipment from the first M2M device is less than a minimum propagation delay, and the SINR of the reference signal at the user equipment from the first M2M is greater than a threshold SINR of reference signals from the M2M devices. The location subsystem 932 may construct the refined location estimate by employing trilateration based on an observed time differences of arrival of reference signals of at least two M2M devices and the base station, or trilateration based on an observed time differences of arrival of reference signals of at least three M2M devices. The location subsystem 932 may employ the M2M measurement reports to compute the refined location estimate of the user equipment as a function of angle of arrivals of reference signals from the M2M devices. The location subsystem 932 may use a timing advance and an average angle of arrival from the angle of arrivals of reference signals from the M2M devices to construct the refined location estimate for the user equipment. Additionally, the M2M measurement reports may include an observed time difference between estimated M2M reference signal timing and estimated downlink base station timing at the user equipment, an estimated M2M reference signal SINR at the user equipment, and a M2M device identifier.

When the communication element 910 is formed as a machine-to-machine device, the memory 950 and computer program code is configured to, with the processor 920, provide reference signals to the user equipment in response to a signal from the base station. In one embodiment, the resource manager 928 of the processor 920 is configured to provide reference signals to the user equipment in response to a signal from the base station. The reference signals are then employed by the user equipment to create M2M measurement reports employable by the base station and SMLC to determine a location estimate (a refined location estimate) of the user equipment. The reference signals are typically low power signals transmitted to the user equipment. The resource manager 932 may receive transmit timing information from the base station to transmit the low power reference signals. The reference signals may accompany operational data produced by the M2M device adjusted with the transmit timing information. The low power reference signal may be transmitted in a subframe with a periodicity obtained from the base station.

The execution of all or portions of particular functions or processes related to management of resources may be performed in equipment separate from and/or coupled to the communication element 910, with the results of such functions or processes communicated for execution to the communication element 910. The processor 920 of the communication element 910 may be of any type suitable to the local application environment, and may include one or more of general-purpose computers, special-purpose computers, microprocessors, digital signal processors (“DSPs”), field-programmable gate arrays (“FPGAS”), application-specific integrated circuits (“ASICS”), and processors based on a multi-core processor architecture, as non-limiting examples.

The transceiver 970 of the communication element 910 modulates information onto a carrier waveform for transmission by the communication element 910 via the antenna 960 to another communication element. The transceiver 970 demodulates information received via the antenna 960 for further processing by other communication elements. The transceiver 970 is capable of supporting duplex operation for the communication element 910.

The memory 950 of the communication element 910, as introduced above, may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. The programs stored in the memory 950 may include program instructions or computer program code that, when executed by an associated processor, enable the communication element 910 to perform tasks as described herein. Of course, the memory 950 may form a data buffer for data transmitted to and from the communication element 910. Exemplary embodiments of the system, subsystems, and modules as described herein may be implemented, at least in part, by computer software executable by processors of, for instance, the user equipment and the local area support node, or by hardware, or by combinations thereof. The systems, subsystems and modules may be embodied in the communication element 910 as illustrated and described herein.

Program or code segments making up the various embodiments of the present invention may be stored in a computer readable medium or transmitted by a computer data signal embodied in a carrier wave, or a signal modulated by a carrier, over a transmission medium. For instance, a computer program product including a program code stored in a computer readable medium may form various embodiments of the present invention. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, an optical disk, a hard disk, a fiber optic medium, a radio frequency (“RF”) link, and the like. The computer data signal may include any signal that can propagate over a transmission medium such as electronic communication network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, added, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-45. (canceled)

46. An apparatus, comprising:
a processor; and
memory including computer program code;
said memory and said computer program code configured to, with said processor, cause said apparatus to perform at least the following:
receive a list of machine-to-machine device identifiers for machine-to-machine devices;
produce machine-to-machine measurement reports based of reference signals from said machine-to-machine devices on said list; and
prepare said machine-to-machine measurement reports for transmission to a base station to determine a position of said apparatus.

47. The apparatus as recited in claim 46 wherein said list of machine-to-machine device identifiers for said machine-to-machine devices is based on a location estimate of said apparatus.

48. The apparatus as recited in claim 46 wherein said list of machine-to-machine device identifiers for said machine-to-machine devices is based on a location estimate in accordance with an initial angle of arrival and timing advance location calculation of said apparatus.

49. The apparatus as recited in claim 46 wherein each of said machine-to-machine measurement reports comprise:
an observed time difference between estimated machine-to-machine reference signal timing and an estimated downlink timing from said base station to said apparatus,
an estimated machine-to-machine reference signal signal-to-interference-and-noise ratio at said apparatus, and
a machine-to-machine device identifier.

50. The apparatus as recited in claim 46 wherein said machine-to-machine devices are synchronized with said base station.

51. A computer program product comprising a program code stored in a computer readable medium configured to:
receive a list of machine-to-machine device identifiers for machine-to-machine devices;
produce machine-to-machine measurement reports based of reference signals from said machine-to-machine devices on said list; and
prepare said machine-to-machine measurement reports for transmission to a base station to determine a position of said apparatus.

52. A method, comprising:
receiving a list of machine-to-machine device identifiers for machine-to-machine devices;
producing machine-to-machine measurement reports based of reference signals from said machine-to-machine devices on said list; and
preparing said machine-to-machine measurement reports for transmission to a base station to determine a position of a user equipment.

53. The method as recited in claim 52 wherein said list of machine-to-machine device identifiers for said machine-to-machine devices is based on a location estimate of said user equipment.

54. The method as recited in claim 52 wherein said list of machine-to-machine device identifiers for said machine-to-machine devices is based on a location estimate in accordance with an initial angle of arrival and timing advance location calculation of said user equipment.

55. An apparatus, comprising:
a processor; and
memory including computer program code;
said memory and said computer program code configured to, with said processor, cause said apparatus to perform at least the following:
compute a location estimate for a user equipment by performing an initial angle of arrival and timing advance location calculation therefor;
receive a list of machine-to-machine device identifiers for machine-to-machine devices dependent on said location estimate for transmission to said user equipment;
enable resources for reference signals to be transmitted between said machine-to-machine devices and said user equipment for preparation of machine-to-machine measurement reports; and
provide said machine-to-machine measurement reports received from said user equipment to a serving mobile location center to determine a position of said user equipment.

56. The apparatus as recited in claim 55 wherein said initial angle of arrival is determined in accordance with a grid of beams or an eigenvalue obtained from a singular value decomposition of an uplink signal from said user equipment.

57. The apparatus as recited in claim 55 wherein said initial angle of arrival is determined based on previous machine-to-machine measurement reports received from said user equipment and known locations of said machine-to-machine devices.

58. A computer program product comprising a program code stored in a computer readable medium configured to:
compute a location estimate for a user equipment by performing an initial angle of arrival and timing advance location calculation therefor;
receive a list of machine-to-machine device identifiers for machine-to-machine devices dependent on said location estimate for transmission to said user equipment;
enable resources for reference signals to be transmitted between said machine-to-machine devices and said user equipment for preparation of machine-to-machine measurement reports; and
provide said machine-to-machine measurement reports received from said user equipment to a serving mobile location center to determine a position of said user equipment.

59. A method, comprising:
computing a location estimate for a user equipment by performing an initial angle of arrival and timing advance location calculation therefor;
receiving a list of machine-to-machine device identifiers for machine-to-machine devices dependent on said location estimate for transmission to said user equipment;
enabling resources for reference signals to be transmitted between said machine-to-machine devices and said user equipment for preparation of machine-to-machine measurement reports; and
providing said machine-to-machine measurement reports received from said user equipment to a serving mobile location center to determine a position of said user equipment.

60. An apparatus, comprising:
a processor; and
memory including computer program code;
said memory and said computer program code configured to, with said processor, cause said apparatus to perform at least the following:
construct a list of machine-to-machine device identifiers for machine-to-machine devices dependent on a location estimate for a user equipment;
prepare said list of machine-to-machine device identifiers for transmission to said user equipment; and
construct a refined location estimate for said user equipment based on machine-to-machine measurement reports dependent on reference signals from said machine-to-machine devices on said list at said user equipment.

61. The apparatus as recited in claim 60 wherein said memory and said computer program code are further configured, with said processor, to construct said refined location estimate with respect to a particular machine-to-machine device if an observed time difference of arrival of a reference signal at said user equipment from said particular machine-to-machine device is less than a minimum propagation delay and a signal-to-interference-and-noise-ratio of said reference signal at said user equipment is greater than a threshold signal-to-interference-and-noise-ratio.

62. The apparatus as recited in claim 60 wherein said memory and said computer program code are further configured, with said processor, to construct said refined location estimate in accordance with trilateration based on observed time differences of arrival of reference signals from at least two machine-to-machine devices and a base station, or at least three machine-to-machine devices.

63. The apparatus as recited in claim 60 wherein said memory and said computer program code are further configured, with said processor, to construct said refined location estimate in accordance with a timing advance and an average angle of arrival from angles of arrival from said machine-to-machine devices to said user equipment.

64. A computer program product comprising a program code stored in a computer readable medium configured to:
construct a list of machine-to-machine device identifiers for machine-to-machine devices dependent on a location estimate for a user equipment;
prepare said list of machine-to-machine device identifiers for transmission to said user equipment; and
construct a refined location estimate for said user equipment based on machine-to-machine measurement reports dependent on reference signals from said machine-to-machine devices on said list at said user equipment.

65. A method, comprising:
constructing a list of machine-to-machine device identifiers for machine-to-machine devices dependent on a location estimate for a user equipment;
preparing said list of machine-to-machine device identifiers for transmission to said user equipment; and
constructing a refined location estimate for said user equipment based on machine-to-machine measurement reports dependent on reference signals from said machine-to-machine devices on said list at said user equipment.
